(19) United States
(12) Patent Application Publication
(10) Pub. No.: US 2020/0089454 A1
(43) Pub. Date: Mar. 19, 2020

(54) PRINTING SYSTEM, PRINTING METHOD AND COMPUTER-READABLE RECORDING MEDIUM

(71) Applicant: KONICA MINOLTA, INC., Tokyo (JP)

(72) Inventor: Ryosuke INODA, Tokyo (JP)

(73) Assignee: KONICA MINOLTA, INC., Tokyo (JP)

(21) Appl. No.: 16/565,621

(22) Filed: Sep. 10, 2019

(30) Foreign Application Priority Data
Sep. 14, 2018 (JP) 2018-172623

(51) Int. Cl. G06F 3/12

(52) U.S. Cl. CPC G06F 3/1296; G06F 3/1293

(57) ABSTRACT

A printing system includes print controllers provided respectively for print engines and a hardware processor that selects a print controller for performing job allocation processing for determining a job executing printer, from the print controllers. The print controller is capable of performing first processing (job allocation processing) for performing job allocation processing and second processing (RIP processing) for generating drawing data for execution of a print job by the relevant print engine, and when a print job is provided from a client terminal, the hardware processor estimates efficiency of processing of the print job, and based on a result of the estimation, determines a print controller for performing job allocation processing.

### CROSS REFERENCE TO RELATED APPLICATIONS

The entire disclosure of Japanese Patent Application No. 2018-172623 filed on Sep. 14, 2018 is incorporated herein by reference in its entirety.

### BACKGROUND

### Technological Field

The present invention relates to a printing system, a printing method and a computer-readable recording medium and specifically relates to a technique that is favorable for allocation processing for printers in a network printing system.

### Description of Related Art

Conventionally, network printing systems in which client terminals such as PCs (personal computers) and printers are provided on a computer network such as a LAN (local area network) so that the plurality of client terminals can share the printers have been known (see, for example, Japanese Patent Application Laid-Open No. 2004-341869). In the network printing systems, a plurality of print jobs can be allocated to different printers to perform printing and one print job can be shared by a plurality of printers to perform printing in cooperation, enabling an increase in speed of print processing.

Printers used in a network printing system are each called a network printer, which normally includes a print controller that performs, e.g., RIP (raster image processor) processing. Also, in a network printing system, for example, one of print controllers incorporated in printers functions as a print server that receives a print job from a client terminal and allocates the print job to a printer that is most suitable for printing (hereinafter referred to as “job executing printer”). Also, for example, in a network printing system, for example, a PC may be used as a print server.

In other words, a print job from a client terminal is transmitted to a print server (for example, a particular print controller) and print data is analyzed by the print controller to select a job executing printer. Then, the print data is transmitted to the job executing printer and RIP processing is performed in a print controller of the job executing printer. A print engine of the job executing printer executes printing based on drawing data resulting from conversion by the RIP processing.

As described above, in a conventional network printing system, print job allocation processing is performed by a print server (for example, a particular print controller). A processing load of the print job allocation processing is relatively large because the print job allocation processing includes print job analysis processing. Therefore, if print jobs are successively transmitted from client terminals, print job allocation processing may be stagnated, resulting in delay in print processing.

### SUMMARY

An object of the present invention is to provide a printing system, a printing method and a computer-readable recording medium that enable an increase in speed of print processing by effective use of existing computer resources on a network.

To achieve at least one of the abovementioned objects, according to an aspect of the present invention, a printing system reflecting one aspect of the present invention includes a client terminal and a plurality of printers including print engines, the client terminal and the plurality of printers being connected via a network, a print job from the client terminal being executed by a job executing printer selected from the plurality of printers, the printing system comprising:

print controllers provided respectively for the print engines;

a hardware processor that selects a print controller that performs job allocation processing for determining the job executing printer, from the print controllers, wherein:

each print controller is capable of executing first processing for performing the job allocation processing and second processing for generating drawing data for execution of the print job by the relevant print engine; and

when the print job is provided from the client terminal, the hardware processor estimates efficiency of processing of the print job, and based on a result of the estimation, determines the print controller that performs the job allocation processing.

To achieve at least one of the abovementioned objects, according to an aspect of the present invention, a printing method reflecting one aspect of the present invention is a printing method for executing a print job from a client terminal via a job executing printer selected from a plurality of printers including print engines, the client terminal and the plurality of printers being connected via a network, the printing method comprising:

receiving the print job provided from the client terminal; and

upon reception of the print job in the receiving, estimating efficiency of processing of the print job, and based on a result of the estimating, selecting a print controller that performs job allocation processing from print controllers provided respectively for the print engines.

To achieve at least one of the abovementioned objects, according to an aspect of the present invention, a non-transitory computer-readable recording medium reflecting one aspect of the present invention is a medium storing a program causing a computer in a printing system including a client terminal and a plurality of printers including print engines, the client terminal and the plurality of printers being connected via a network, a print job from the client terminal being executed by a job executing printer selected from the plurality of printers, to perform:

receiving the print job provided from the client terminal; and

upon reception of the print job in the receiving, estimating efficiency of processing of the print job, and based on a result of the estimation, determining a print controller for performing job allocation processing from print controllers provided respectively for the print engines.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a schematic configuration of a network printing system according to an embodiment;

FIG. 2 illustrates an example of a hardware configuration of a print server;

FIG. 3 illustrates a hardware configuration of a printer;

FIG. 4 is a flowchart illustrating an example of print processing to be executed in the network printing system;

FIG. 5 is a flowchart illustrating an example of allocation processing controller selection processing performed in a print server;

FIG. 6 is a flowchart illustrating an example of job allocation processing to be executed in a print server or a print controller;

FIG. 7 illustrates an example of a rank determination table for calculating a rank value for each printer; and

FIG. 8 illustrates an example of a criterion table to be referred to where rank values are the same.

### DETAILED DESCRIPTION OF EMBODIMENTS

Hereinafter, one or more embodiments of the present invention will be described with reference to the drawings. However, the scope of the invention is not limited to the disclosed embodiments.

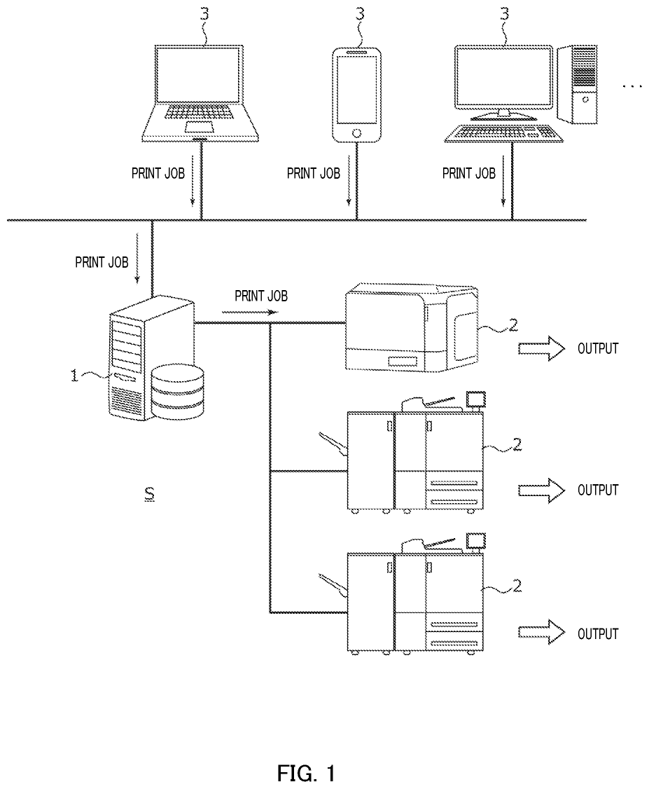

FIG. 1 illustrates a schematic configuration of network printing system S according to an embodiment of the present invention (hereinafter referred to as “printing system S”).

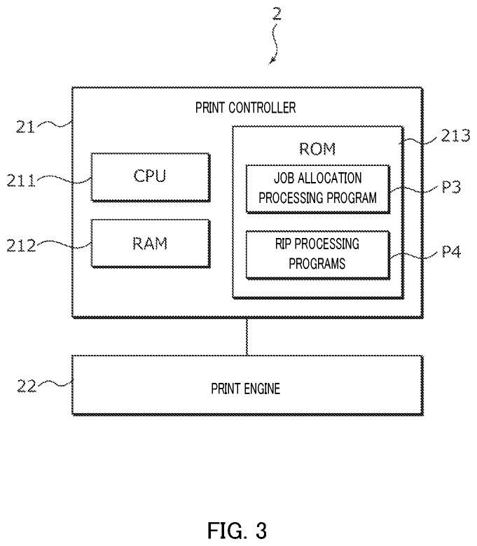

As illustrated in FIG. 1, printing system S includes print server 1, printers 2 and client terminals 3. Print server 1, printers 2 and client terminals 3 are connected in a mutually communicable manner via a communication network, for example, a corporate LAN. In printing system S, print server 1 receives a print job transmitted from client terminal 3, selects a job executing printer suitable for printing from printers 2 and allocates the print job to the job executing printer. Printer 2 selected as a job executing printer performs RIP processing on relevant print data via print controller 21 (see FIG. 3) of printer 2 and performs printing via print engine 22 (see FIG. 3) based on drawing data generated as a result of the RIP processing.

Here, RIP processing refers to processing for converting print data described in a page description language (PDL), for example, PostScript or PCL (Printer Control Language) into drawing data that print engine 22 can understand (for example, raster data such as BMP (bitmap)). Examples of the print data include data of an image object such as a figure or a photo and data of a text object such as characters and symbols.

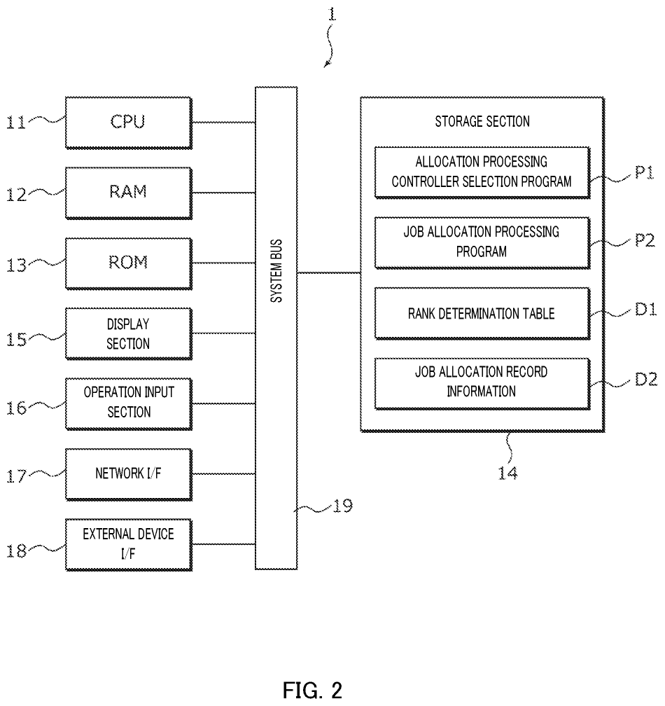

FIG. 2 illustrates an example of a hardware configuration of print server 1.

As illustrated in FIG. 2, print server 1, which is formed of, for example, a general-purpose PC, includes CPU (central processing unit) 11, which serves as an arithmetic/control apparatus, RAM (random access memory) 12 and ROM (read-only memory) 13, which serve as a main storage apparatus, storage section 14, display section 15, operation input section 16, network I/F 17 and external device I/F 18. Respective units 12 to 18 are connected to CPU 11 via system bus 19.

In ROM 13, for example, basic programs such as BIOS (Basic Input/Output System) and firmware and fundamental setting data are stored. CPU 11 implements various functions by reading a program according to a content of processing from storage section 14, loading the program onto RAM 12 and executing the loaded program.

In the present embodiment, CPU 11 executes allocation processing controller selection program P1 stored in storage section 14 to select an allocation processing controller for performing print job allocation processing from print controllers 21 of printers 2 (processing as an allocation processing controller selection section). Also, CPU 11 executes job allocation processing program P2 stored in storage section 14 to determine a job executing printer and perform print job allocation processing (processing as a job allocation processing section).

Storage section 14 is an auxiliary storage apparatus such as, for example, a non-volatile semiconductor memory (what is called a flash memory) or a hard disk drive. Storage section 14 may be a disk drive that drives an optical disk such as a CD (compact disc), a DVD (digital versatile disc) or a BD (Blu-ray disc; “Blu-ray” is a registered trademark) or a magneto-optical disk such as an MO (magneto-optical disc) to read/write information.

In the present embodiment, storage section 14 stores, for example, allocation processing controller selection program P1, job allocation processing program P2, rank determination table D1 to be referred to in allocation processing controller selection processing and job allocation record information D2 indicating print job allocation records.

Note that a RIP processing program may be stored in storage section 14 to enable RIP processing to be performed in print server 1. For example, if printer 2 includes no print controller 21, RIP processing is performed in print server 1 and the resulting drawing data is transmitted to printer 2 (what is called software RIP processing).

Display section 15 is formed of, for example, a liquid-crystal display, an organic EL display or a CRT display. Display section 15 displays a screen according to an instruction from CPU 11.

Operation input section 16 includes a numeric key pad, various operation keys such as a start key and a pointing device such as a mouse, and receives various inputs provided via user's operations and outputs operation signals to CPU 11. For example, a user can update rank determination table D1 or change data relating to printers 2 on the network by operating operation input section 16.

Note that display section 15 and operation input section 16 may be integrally provided by, for example, a touch panel-equipped flat panel display.

Network I/F 17 is an interface for communication with an external device via a communication network such as a wired/wireless LAN (local area network). CPU 11 transmits/receives various types of information to/from external devices connected to the network (for example, printers 2 and client terminals 3), via network I/F 17.

External device I/F 18 is an interface for connection of an external device via a communication bus such as a USB (Universal Serial Bus). CPU 11 transmits/receives various types of information to/from an external device connected to external device I/F 18.

FIG. 3 illustrates an example of a configuration of a major part of printer 2.

Printer 2 forms an image on a sheet using, for example, an electrophotographic process technique. Printer 2 may be a monochromatic printer or a color printer.

As illustrated in FIG. 3, printer 2, which is formed of, for example, a general network printer, includes print controller 21 and print engine 22. In other words, print controller 21 is provided for relevant print engine 22. Normally, printer 2 also includes a main control section that performs concentrated control of respective blocks, a storage section, an image processing section, a display section, an operation input section, a network I/F and an external device I/F. These components are publicly known, and thus, illustration and description thereof will be omitted.

Print controller 21 is formed of, for example, a one-chip microcomputer. Print controller 21 includes CPU 211, which serves as an arithmetic/control apparatus, and RAM 212 and ROM 213, which serve as a main storage apparatus. ROM 213 stores, for example, job allocation processing program P3 and RIP processing programs P4. For example, RIP processing programs P4 are provided for respective kinds of page description languages for print jobs, and RIP processing program P4 for a page description language of a print job to be processed is appropriately loaded to RAM 212 and executed.

CPU 211 executes job allocation processing program P3 stored in ROM 213 to determine a job executing printer and perform print job allocation processing (processing as a job allocation processing section). Also, CPU 211 executes RIP processing program P4 stored in ROM 213 to convert print data into drawing data (processing as a RIP processing section).

As with conventional techniques, print controller 21 functions as a RIP processing section. The present embodiment is characteristic in that print controller 21 functions also as a job allocation processing section. Since each of job allocation processing and RIP processing needs detailed analysis of print data (PDL data) included in a print job and thus consumes large hardware resources.

Print engine 22 performs printing on a sheet based on drawing data output from print controller 21. Print engine 22 includes, for example, a toner image forming section, an intermediate transfer section and a fixing section. The toner image forming section forms a toner image using respective color toners of Y, M, C and K components, based on input image data (where printer 2 is a color printer). The intermediate transfer section transfers the toner image formed by the toner image forming section onto a sheet. The fixing section fixes the transferred toner image to the sheet. Note that the configuration of print engine 22 is publicly known and detailed description thereof will be omitted.

In printing system S, in response to a print request from client terminal 3, a print job is provided to print server 1. Then, a job executing printer is selected from printers 2 by means of print job allocation processing in print server 1 and the print job is allocated to the job executing printer. Here, for example, one print job may be divided on a page basis and allocated to a plurality of printers 2. For example, print processing can efficiently be performed by allocating print data of color pages included in a print job to color printer 2 and allocating print data of monochromatic pages included in the print job to monochromatic printer 2.

Upon reception of the print data from print server 1, printer 2 selected as a job executing printer performs RIP processing of the print data via print controller 21 to convert the print data into drawing data. Also, print engine 22 of printer 2 executes printing based on the drawing data generated via print controller 21.

Although print job allocation processing is normally performed by print server 1 that has received a print job, in the present embodiment, not only print server 1, but also print controller 21 of printer 2 performs print job allocation processing.

For example, while print server 1 is performing print job allocation processing, and then if print server 1 receives another print job, it is difficult to immediately perform subsequent print job allocation processing, and in such case, any of print controllers 21 performs print job allocation processing.

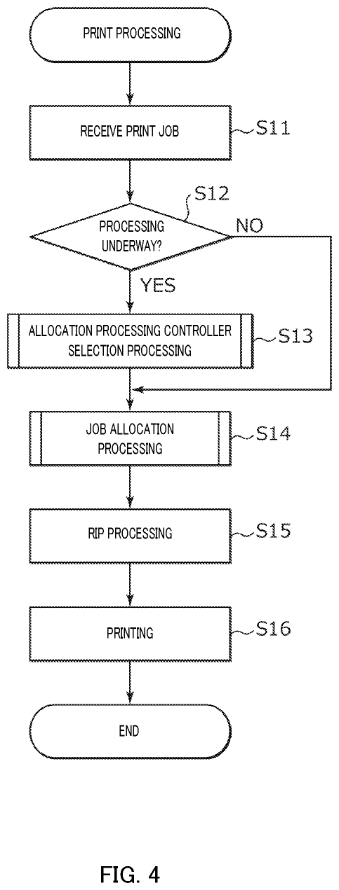

FIG. 4 is a flowchart illustrating an example of print processing to be performed in printing system S.

In step S11 in FIG. 4, in response to a print request from client terminal 3, print server 1 receives a print job.

In step S12, print server 1 determines whether or not print job processing is underway. “Print job processing is underway” may refer to print job allocation processing being underway, and if RIP processing is performed in print server 1, may refer to RIP processing being underway.

If print job processing is underway (“YES” in step S12), print server 1 proceeds to processing in step S13. If no print job processing is underway (“NO” in step S12), print server 1 proceeds to processing in step S14.

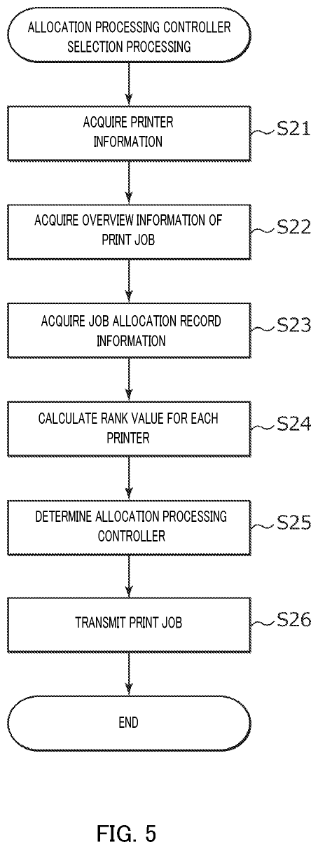

In step S13, print server 1 performs allocation processing controller selection processing. In other words, in print server 1, if print job processing is underway, processing for allocation of the provided print job cannot immediately be executed, and thus, print job allocation processing is performed using print controller 21 of printer 2. More specifically, the allocation processing controller selection processing is performed according to the flowchart illustrated in FIG. 5.

FIG. 5 is a flowchart illustrating an example of allocation processing controller selection processing. This processing is implemented by execution of allocation processing controller selection program P1 by CPU 11 of print server 1.

In step S21 in FIG. 5, CPU 11 of print server 1 acquires information relating to print controller 21 and information relating to print engine 22 as printer information of each of printers 2 connected to the network.

The information relating to print controller 21 includes, for example, at least one of hardware information of print controller 21 (for example, a processing speed of CPU 211), processing load information indicating a current processing status (for example, CPU utilization by job allocation processing and RIP processing) and software information indicating supported page description languages (for example, PostScript, PCL, PDF (Portable Document Format), PDF/VT (Variable Transactional), XPS (XML Paper Specification) and PPML (Personalized Print Markup Language)).

The information relating to print engine 22 includes, for example, at least one of information of a printing speed of print engine 22, color information indicating kinds of printable colorants (CMYK) and internal status information indicating a printing status (for example, error information such as sheet tray being full, no sheet, no colorant, a sheet jam or a service call error).

Note that the hardware information and the software information of print controller 21 and the printing speed information and the color information of print engine 22 in the printer information do not need to be acquired from each printer 2 each time the flowchart in FIG. 5 is executed and may be, for example, stored in a cache memory (illustration thereof omitted) in advance, and acquired by being read from the cache memory.

In step S22, CPU 11 of print server 1 analyzes the provided print job and acquires overview information of the print job. The overview information of the print job includes, for example, PDL information indicating a kind of page description language of the print job. A kind of page description language of a print job can be acquired at high speed by analyzing a file header of the relevant print data alone.

In step S23, CPU 11 of print server 1 acquires job allocation record information D2 indicating print job allocation records (see FIG. 2). A frequency of use of each printer 2, that is, a possibility of use of each printer 2 as a job executing printer can be grasped from job allocation record information D2.

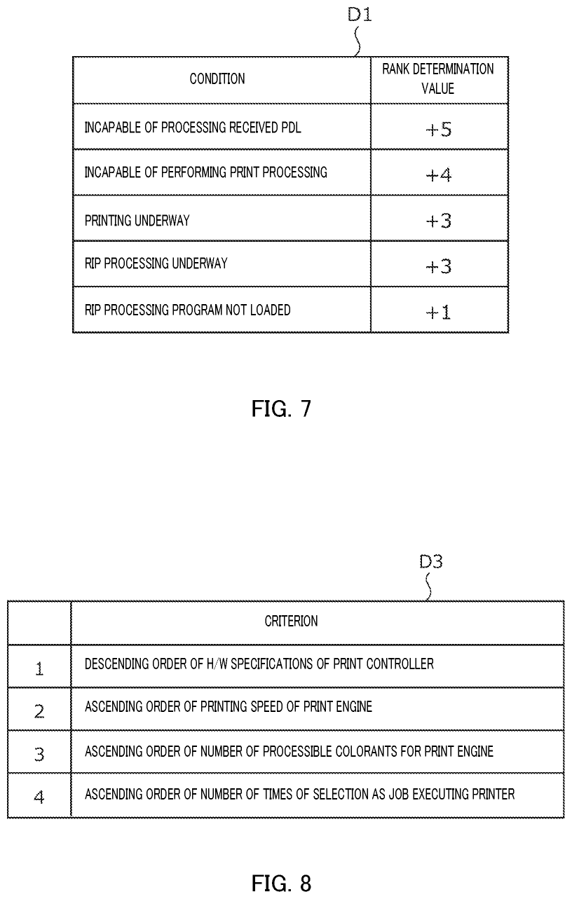

In step S24, CPU 11 of print server 1 calculates a rank value for each printer 2. The rank value calculation is performed with reference to, for example, rank determination table D1 (see FIG. 2). FIG. 7 illustrates an example of rank determination table D1. Note that rank determination conditions and the rank determination values indicated in FIG. 7 are mere examples and rand determination conditions may be added or deleted and rank determination values may be increased or decreased according to a user environment.

In rank determination table D1 in FIG. 7, “incapable of processing received PDL”, “incapable of performing print processing”, “printing underway”, “RIP processing underway” and “RIP processing program not loaded” are provided as rank determination conditions, and are associated with rank determination values “+5”, “+4”, “+3”, “+3” and “+1”, respectively.

“Incapable of processing received PDL” indicates that print controller 21 does not support a page description language of a provided print job, and whether or not that condition is met is determined based on information of print controller 21.

“Incapable of performing print processing” indicates that print engine 22 cannot perform printing because of, for example, a sheet feed error, and whether or not that condition is met is determined based on information of print engine 22.

“Printing underway” indicates that printing is underway in print engine 22, and whether or not that condition is met is determined based on information of print engine 22.

“RIP processing underway” indicates that RIP processing is underway in print controller 21, and whether or not that condition is met based on information of print controller 21.

“RIP processing program not loaded” indicates that RIP processing program P4 is not loaded in RAM 212 in print controller 21, and whether or not that condition is met is determined based on information of print controller 21.

As described above, in rank determination table D1, larger rank determination values are assigned in descending order of possibility of print controller 21 being not used for execution of the print job. For example, print controller 21 meeting the condition, “incapable of processing received PDL” has no possibility of performing RIP processing of the print job, and thus is assigned with the largest rank determination value “+5”.

In step S24 in FIG. 5, for each print controller 21, rank determination values of conditions met by print controller 21 from among the conditions defined in rank determination table D1 are added up to calculate a rank value for print controller 21. For example, a rank value of print controller 21 of printer 2 meeting the conditions “incapability of processing received PDL” (rank determination value: +5) and “printing underway” (rank determination value: +3) in rank determination table D1 is “+8”.

If a rank value of print controller 21 is larger, print controller 21 is more likely not to be used for execution of the print job (no RIP processing is more likely to be performed). Therefore, as a result of print controller 21 having a larger rank value being selected as an allocation processing controller, a situation in which print job allocation processing and RIP processing are performed in parallel is less likely to occur and efficiency of processing the print job is enhanced. In other words, a rank value of print controller 21 definitely indicates print job processing efficiency where print controller 21 is selected as an allocation processing controller.

In step S25, CPU 11 of print server 1 determines an allocation processing controller based on the rank values calculated in step S24. More specifically, the CPU 11 selects print controller 21 whose calculated rank value is largest, that is, print controller 21 of printer 2 that is least likely to be selected as a job executing printer, as an allocation processing controller. In other words, for each print controller 21, CPU 11 estimates efficiency of processing the provided print job where processing for allocating the print job is executed by print controller 21, and based on a result of the estimation, selects an allocation processing controller.

Note that if a plurality of print controllers 21 have a same rank value, for example, an allocation processing controller is determined based on a preset criterion. FIG. 8 illustrates an example of criterion table D3 to be referred to where rank values are the same. Like rank determination table D1, criterion table D3 is stored in, for example, storage section 14 of print server 1.

In criterion table D3 illustrated in FIG. 8, four criterions that are criterion 1 “descending order of hardware specifications of the print controller”, criterion 2 “descending order of printing speed of the print engine”, criterion 3 “ascending order of the number of processible colorants for the print engine” and criterion 4 “ascending order of the number of times of use as a job executing printer” are set.

If a plurality of print controllers 21 have a same rank value, the criterions are referred to in order from top criterion 1, and which print controller 21 provides highest efficiency of processing the provided print job if selected as an allocation processing controller is determined. For example, if print controllers 21 are different in hardware specifications, print controller 21 having higher hardware specifications provide higher efficiency of processing the provided print job and thus is suitable for an allocation processing controller.

Then, if determination cannot be made according to a higher-level criterion, determination according to a lower-level criterion is made. In other words, these criterions also definitely indicate print job processing efficiency if print controller 21 is selected as an allocation processing controller.

In step S26, CPU 11 of print server 1 transmits the print job to print controller 21 selected as an allocation processing controller. This print job is received by transmission destination print controller 21.

In such a manner as above, the allocation processing controller selection processing is performed in print server 1. Consequently, print controller 21 of printer 2 that is least likely to be selected as a job executing printer for the print job, that is, print controller 21 providing highest efficiency of processing the print job, is selected as an allocation processing controller.

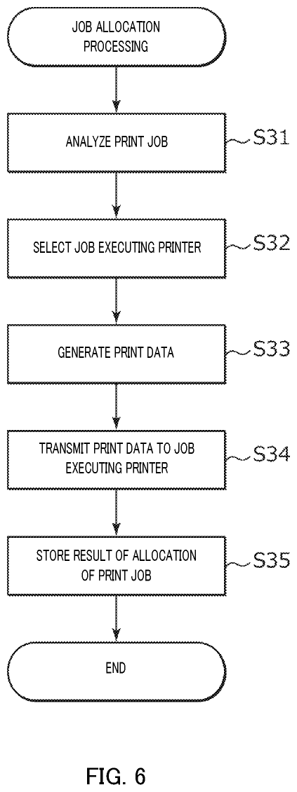

Next, in step S14 in FIG. 4, print server 1 or print controller 21 selected in step S13 performs print job allocation processing. If no print job processing is underway in print server 1 (“NO” in step S12), job allocation processing is performed in print server 1, and if print job processing is underway (“YES” in step S12), job allocation processing is performed in print controller 21 selected in step S13. More specifically, the job allocation processing is executed according to the flowchart illustrated in FIG. 6.

FIG. 6 is a flowchart illustrating an example of job allocation processing. This processing is implemented by, for example, execution of job allocation processing program P3 by CPU 211 of print controller 21 selected as an allocation processing controller.

Note that processing by CPU 211 of print controller 21 will be described herein; however, the same applies to job allocation processing by CPU 11 of print server 1.

In step S31 in FIG. 6, CPU 211 of print controller 21 analyzes the print job. As a result of the analysis of the print job, for example, color information (color or monochromatic) of print data (PDL data) included in the print job is acquired.

In step S32, CPU 211 of print controller 21 selects a job executing printer for executing the print job, based on a result of the analysis of the print job. For processing for the job executing printer selection, a publicly known technique can be employed, and for example, a job executing printer is selected in a preset order of priority. For example, if the print data is color data, the job executing printer is selected from color printers 2, and if the print data is monochromatic data, the job executing printer is selected from monochromatic printers 2. Also, for example, printer 2 that is not currently under print processing is preferentially selected as the job executing printer.

Note that the color information of the print data may be analyzed on a page basis and based on a result of the analysis, the print job may be divided according to respective pages and allocated to a plurality of job executing printers. Also, one printer 2 or a plurality of printers 2 may be selected as the job executing printer(s).

In step S33, CPU 211 of print controller 21 generates print data as necessary. For example, if the print job is divided according to the respective pages and allocated to a plurality of job executing printers, CPU 211 generates print data for the respective job executing printers (for example, color print data and monochromatic print data).

In step S34, CPU 211 of print controller 21 transmits the generated print data to printer 2 selected as the job executing printer. The transmitted print data is received by printer 2 selected as the job executing printer.

In step S35, CPU 211 of print controller 21 stores a result of the print job allocation. More specifically, the result of the print job allocation is transmitted to print server 1 and stored in storage section 14 of print server 1 as job allocation record information D2. Job allocation record information D2 is used where print controllers 21 have a same rank value and print job processing efficiency is estimated for each print controller using the criterions in allocation processing controller selection processing (see FIG. 5).

In such a manner as above, the print job allocation processing is performed in print controller 21. Print controller 21 is a print controller of printer 2 that is least likely to be selected as a job executing printer for the print job and possibility of job allocation processing and RIP processing for the print job being executed in parallel is low, enabling job allocation processing to be performed at high speed. In other words, in the present embodiment, free print controller 21 that does not perform RIP processing of a provided print job is effectively used as an allocation processing controller, enabling an increase in speed of print processing.

Next, in step S15 in FIG. 4, print controller 21 of the job executing printer performs RIP processing of the print data transmitted from print controller 21 serving as an allocation processing controller (which is different from print controller 21 of the job executing printer).

Also, in step S16, print engine 22 of the job executing printer performs printing on a sheet based on drawing data generated as a result of the RIP processing.

As described above, printing system S according to the embodiment is a print job printing system including client terminal 3 and a plurality of printers 2 each including print engine 22, client terminal 3 and the plurality of printers 2 being connected via a network, a job executing printer selected from the plurality of printers 2 executing a print job from client terminal 3, the print job printing system including: print controller 21 provided for each print engine 22; and print server 1 that selects print controller 21 that performs job allocation processing for determining the job executing printer, from print controllers 21 (allocation processing controller selectin section). Print controller 21 includes a job allocation processing section that performs job allocation processing (first processing section) and a RIP processing section that generates drawing data for execution of the print job by relevant print engine 22 (second processing section). When the print job is provided from client terminal 3, print server 1 estimates efficiency of processing of the print job, and based on a result of the estimation, determines the print controller that performs the job allocation processing.

Also, the printing method according to the embodiment is a printing method for executing a print job from client terminal 3 via a job executing printer selected from a plurality of printers 2 each including print engine 22, client terminal 3 and the plurality of printers 2 being connected via a network, the printing method including: a first step of receiving the print job provided from client terminal 3 (step S11 in FIG. 4); and a second step of, upon the reception of the print job in the first step, estimating efficiency of processing of the print job, and based on a result of the estimation, selecting a print controller that performs job allocation processing from print controllers 21 provided respectively for print engines 22 (step S13 in FIG. 4, and FIG. 5).

Also, the program according to the embodiment causes a computer in a printing system S including client terminal 3 and a plurality of printers 2 each including print engine 22, client terminal 3 and the plurality of printers 2 being connected via a network, a job executing printer selected from the plurality of printers 2 executing a print job from client terminal 3 (CPU 11 in print server 1) to perform: first processing for receiving the print job provided from client terminal 3 (step S11 in FIG. 4); and second processing for, upon the reception of the print job in the first processing, estimating efficiency of processing of the print job, and based on a result of the estimation, determining a print controller for performing job allocation processing from print controllers 21 provided respectively for print engines 22 (step S13 in FIG. 4, and FIG. 5).

This program is provided, for example, via a computer-readable portable recording medium (which may be an optical disk, a magnetooptical disk or a memory card) with the program stored therein. Also, for example, the program may be provided by being downloaded from a server that holds the program, via a network.

The printing system, the printing method and the program according to the embodiment enable an increase in speed of print processing by effective use of existing computer resources on a network.

In other words, print job allocation processing can efficiently be performed by performing job allocation processing using free print controller 21 that does not perform RIP processing from among print controllers 21 provided respectively for print engines 22.

More specifically, even if print server 1 is under processing, based on a result of estimation of efficiency of processing of a print job, print controller 21 of printer 2 that is less likely to execute the print job is selected as an allocation processing controller that performs job allocation processing, and job allocation processing is performed in print controller 21. Therefore, the print job allocation processing is performed without stagnation, enabling an increase in speed of print processing.

Also, in printing system S, print server 1 (allocation processing controller selection section) estimates the efficiency of processing of the print job, using information relating to each print controller 21, the information including at least one of hardware information of print controller 21, processing load information indicating a current processing status of print controller 21 and software information including a file format supported by print controller 21.

Also, print server 1 (allocation processing controller selection section) estimates the efficiency of processing of the print job, using information relating to each print engine 22, the information including at least one of printing speed information of print engine 22, color information indicating a kind of printable colorant for print engine 22, and internal status information indicating a printing status of print engine 22.

Also, print server 1 (allocation processing controller selection section) estimates the efficiency of processing of the print job, using overview information of the provided print job, the overview information including PDL information indicating a kind of page description language of the print job.

Also, print server 1 (allocation processing controller selection section) estimates the efficiency of processing of the print job, using job allocation record information indicating a record of print job allocation performed previously.

Consequently, the efficiency of processing of the print job, that is, which print controller 21 is to be used for execution of job allocation processing in order to enable print processing at highest speed can be estimated with accuracy.

Although an invention made by the present inventor has specifically been described based on an embodiment, the present invention is not limited to the above-described embodiment and can be changed without departing from the spirit of the invention.

For example, although the embodiment has been described in terms of a case where if print server 1 including an allocation processing controller selection section is under job allocation processing or under RIP processing, allocation processing controller selection processing is performed for print controllers 21, allocation processing controller selection processing may be performed for job allocation processing sections of print server 1 and print controllers 21 irrespective of a processing status of print server 1.

Also, for example, although the embodiment has been described in terms of a case where print server 1 functions as an allocation processing controller selection section, an allocation processing controller selection section may be incorporated in at least one of print controllers 21. In this case, particular print controller 21 that functions as an allocation processing controller selection section functions as a print server. Consequently, there is no need to separately provide a print server using a PC, enabling reduction in system costs.

In this case, if particular print controller 21 is under job allocation processing or under RIP processing, allocation processing controller selection processing may be performed for other print controllers 21 or allocation processing controller selection processing may be performed for print controllers 21 including particular print controller 21 irrespective of a processing status of particular print controller 21.

Also, a plurality of allocation processing controller selection sections may be provided on a same network. Consequently, if a plurality of print jobs are successively provided from client terminal 3, the plurality of allocation processing controller selection sections can receive the plurality of print jobs and perform allocation processing controller selection processing, enabling a further increase in speed of print processing.

Furthermore, print controllers 21 may be provided respectively for print engines 22 and may be each formed of, for example, a PC.

Although embodiments of the present invention have been described and illustrated in detail, the disclosed embodiments are made for purpose of illustration and example only and not limitation. The scope of the present invention should be interpreted by terms of the appended claims.

What is claimed is:

1. A printing system including a client terminal and a plurality of printers including print engines, the client terminal and the plurality of printers being connected via a network, a print job from the client terminal being executed by a job executing printer selected from the plurality of printers, the printing system comprising:
print controllers provided respectively for the print engines;
a hardware processor that selects a print controller that performs job allocation processing for determining the job executing printer, from the print controllers, wherein:
each print controller is capable of executing first processing for performing the job allocation processing and second processing for generating drawing data for execution of the print job by the relevant print engine; and
when the print job is provided from the client terminal, the hardware processor estimates efficiency of processing of the print job, and based on a result of the estimation, determines the print controller that performs the job allocation processing.

2. The printing system according to claim 1, wherein each print controller performs RIP processing of print data included in the print job, as the second processing.

3. The printing system according to claim 1, wherein the hardware processor estimates the efficiency of processing of the print job, using information relating to each printer controller, the information including at least one of hardware information of the print controller, processing load information indicating a current processing status of the print controller and software information including a file format supported by the print controller.

4. The printing system according to claim 1, wherein the hardware processor estimates the efficiency of processing of the print job, using information relating to each print engine, the information including at least one of printing speed information of the print engine, color information indicating a kind of printable colorant for the print engine and internal status information indicating a printing status of the print engine.

5. The printing system according to claim 1, wherein the hardware processor estimates the efficiency of processing of the print job, using overview information of the provided print job, the overview information including PDL information indicating a kind of page description language of the provided print job.

6. The printing system according to claim 1, wherein the hardware processor estimates the efficiency of processing of the print job, using job allocation record information indicating a record of print job allocation performed previously.

7. The printing system according to claim 1, wherein upon simultaneous reception of print jobs, the hardware processor assigns the print jobs to different print controllers to perform the first processing.

8. The printing system according to claim 1, wherein the hardware processor is incorporated in at least one of the print controllers.

9. The printing system according to claim 1, wherein a plurality of the hardware processors are provided on the same network.

10. A printing method for executing a print job from a client terminal via a job executing printer selected from a plurality of printers including print engines, the client terminal and the plurality of printers being connected via a network, the printing method comprising:
receiving the print job provided from the client terminal; and
upon reception of the print job in the receiving, estimating efficiency of processing of the print job, and based on a result of the estimating, selecting a print controller that performs job allocation processing from print controllers provided respectively for the print engines.

11. A non-transitory computer-readable recording medium storing a program causing a computer in a printing system including a client terminal and a plurality of printers including print engines, the client terminal and the plurality of printers being connected via a network, a print job from the client terminal being executed by a job executing printer selected from the plurality of printers, to perform:
receiving the print job provided from the client terminal; and
upon reception of the print job in the receiving, estimating efficiency of processing of the print job, and based on a result of the estimation, determining a print controller for performing job allocation processing from print controllers provided respectively for the print engines.
